(19) United States
(12) Patent Application Publication
(10) Pub. No.: US 2003/0208773 A1
(43) Pub. Date: Nov. 6, 2003

(54) Device for transferring data

(75) Inventor: Charamporn Jotikasthira, Bangkok (TH)

Correspondence Address: MERCHANT & GOULD PC, P.O. BOX 2903, MINNEAPOLIS, MN, 55402-0903, US

(73) Assignee: C & C Jotikasthira Co., Ltd., Bangkok (TH)

(21) Appl. No.: 10/138,051

(22) Filed: May 3, 2002

(51) Int. Cl. H04N 7/173; H04N 7/16

(52) U.S. Cl. 725/114; 725/91; 725/118; 725/148

(57) ABSTRACT

A device and method for handling and transferring data associated with a main broadcast program (e.g. music names, singer names and advertisement) from a broadcast station (radio, television, etc.) or a cable television set top box. Data received can be captured and stored in a main memory by receiving a command from a user by pressing input/output user interface unit. The stored data can be transmitted to another local area transceiver or a personal hand held memory device (PHHM) by means of wireless data transmission or transmitted between PHHM. The data can be displayed by a data display unit installed on a local area transceiver that receives data shared with for instance, a television or radio signal receiver or on a PHHM.

### FIELD OF THE INVENTION

This invention relates to a device for transferring data associated with a main broadcast program. In particular, this invention relates to a device implemented for handling and transferring small and medium sized data associated with a main broadcast program, and relates to a method for handling and transferring the small and medium sized data associated with the main broadcast program.

### BACKGROUND OF THE INVENTION

In the past, some personal digital assistants (PDAs), notably the Palm series of PDAs from US Robotics offer a feature where two users of the same brand of PDAs may exchange name card information through infrared beams using an information exchange protocol. Each PDA is under direct control of two human beings, and the data exchange takes place as a one-time reciprocal transfer.

Recently, attempts have been made to invent a device for recording and displaying television programs, such as in the patent no. EP 1097576 and EP 1079387, and radio programs such as WO 01/22249 A1. These designs are directed to solving the problems for selecting programs, while data associated with the broadcasted programs, such as advertisements, music titles, singers' names, and other data associated with the broadcast were omitted.

U.S. Pat. No. 6,035,217 to Kravitz assigned to Sony Corp. discloses a one button cellular phone, system, and method for use. All basic phone functions are operated by a single button. By pressing the button, a service provider is dialed to connect the user to the service provider. When connected with the service provider, the user communicates the desired number to be called to the service provider, which the service provider connects the user to the desired number. The single button also can be used to answer an incoming call or terminate a call in progress.

When a consumer wants to record data (e.g. music titles, singers' name, product names, advertisement and other data) to buy products or to transmit to other people, present designs cannot accomplish this task without the assistance from personal computers, often employing excessive hardware with elaborate functions that are not conducive for convenience and ease of use. Therefore, there is a need to provide a device and method for handling and transferring small and medium sized data associated with a main broadcast program that is convenient to use, and that minimizes the parts used for operation.

The present invention, as described hereinbelow, provides a data transfer device that conveniently captures, stores, and transmits information data providing improvements upon one or more of the above described, existing and previous data transfer devices.

### SUMMARY OF THE INVENTION

In accordance with the principles of the present invention, a data transfer device for handling and transferring information data includes an input/output unit that improves upon and solves problems associated with previous designs.

In one embodiment, a device for handling and transferring information data includes at least one transceiving unit for transmitting and receiving data from a broadcast station or other local transceiver devices. A control unit is operatively connected with the transceiver, and controls data transmission to and from the device. A main memory is operatively connected to the control unit and is controlled by the control unit for storing data received for immediate or later use or for transmission to other transfer devices. An input/output unit is operatively connected with the control unit. The input/output unit includes at least one command for sending to the control unit in controlling the device.

In one embodiment, the device is incorporated with a local device and includes a wireless transceiving unit and a wireline receiver.

In one embodiment, the device is a personal hand held memory (PHHM) device that includes a wireless transceiving unit.

In one embodiment, the device is incorporated within or coexistent with a hand held device, for example, a television remote control or other remote control device, car key, personal digital assistant (PDA), mobile phone, or pager.

In one embodiment, the device resides within or is coexistent with a data source, such as satellite equipment in a broadcasting station or on a relay device, such as receivers on a television or radio.

In one embodiment the device can be a stand alone device.

In one embodiment, the input/output unit is a binary input/output unit capable of being activated and deactivated for manual control that is operatively connected with the control unit.

In one embodiment, the command for sending to the control unit is defined by a pulse sequence.

In one embodiment, the input/output unit includes a plurality of commands in a command set, where each command is defined by a pulse sequence unique with respect to the other commands in the command set.

In one embodiment, the information data transferred is small or medium sized data associated with a main broadcast program.

In one embodiment, a method for handling and transferring information data includes providing the device as above and entering a command to the input/output unit. The step of entering the command includes at least once activating and deactivating a binary input/output unit in a predetermined pulse sequence to send the command. The input/output unit sends the command to the control unit, and the control unit controls the transceiving unit for receiving information data from another data source or transmitting information data from the memory of the device. Received information data may be stored for later viewing or subsequent information data transfers.

One objective of this invention is to present a data transfer device and a method for convenient transfer of information data for handling subset data associated with a main broadcast program that is small and medium-sized data (e.g. music's titles, singers' name, advertisement or other information data broadcasted from a broadcast station). A user can record the information data by, for instance, pressing a control button installed on an input/output unit of the data transfer device, and can transmit information data to another remote data transfer device installed on a local area device, for instance a television or radio signal receivers or other similar devices, or data transfer device of a PHHM by means of wireless data transmission. The present invention provides a device that can conveniently capture and handle information data associated with a main broadcast program.

These and other various advantages and features of novelty, which characterize the invention, are pointed out in the following detailed description. For better understanding of the invention, its advantages, and the objects obtained by its use, reference should also be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 represents a schematic view of one embodiment of a data transfer device for transferring data implemented in local devices. FIG. 1 represents a schematic view of an embodiment for using the data transfer device in data transmission between a broadcast station and local devices, and data transmission between local devices.

FIG. 2 represents a schematic view of one embodiment of data transmission between a local device and a personal hand held memory device (PHHM).

FIG. 3 shows data transmission between personal hand held memory devices (PHHM).

FIG. 4 represents a schematic view of one embodiment for the main components for a device for transferring data in a local device.

FIG. 5 represents a schematic view of one embodiment for the main components for a device for transferring data in a PHHM.

### DETAILED DESCRIPTION OF THE PREFERRED EMBODIMENT

In the following description of the illustrated embodiments, reference is made to the accompanying drawings that form a part hereof, and in which is shown by way of illustration of the embodiments in which the invention may be practiced. It is to be understood that other embodiments may be utilized as structural changes may be made without departing from the spirit and scope of the present invention.

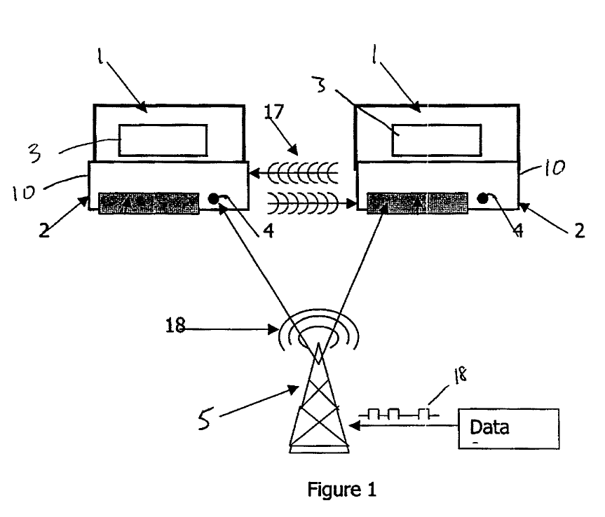

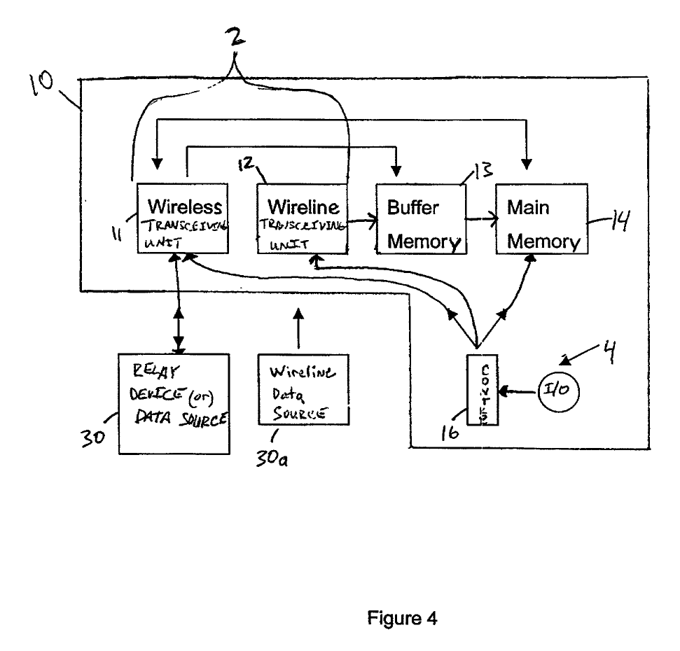

FIG. 1 illustrates a schematic view of data transfer to and from data transfer devices 10 that each include a transceiving unit 2 residing therein. The transceiving units 2 receive information data 18 directly from a broadcast station 5, for instance, a television or radio broadcast station. The transceiving unit 2 for receiving the information data 18 may be a wireless transceiving unit 11 (shown in FIG. 4) or a wireline transceiving unit 12 (shown in FIG. 4). It will be appreciated that the transceiving unit may include one or both of the wireless and wireline transceiving units 11, 12. It will be appreciated that the transceiving units 2 of local devices 1 also may receive data through any relay station capable of relaying information data to the local devices 1, or receive data through wired means such as a cable television control box (shown in FIG. 4). The data transfer devices 10 are shown incorporated within or coexistent with local devices 1, such as but not limited to a radio, television, and cable receiver.

The broadcast station 5 transmits programs for users to watch, listen and experience. Such programs include but are not limited to a television program, a song, a billboard, or a commercial display. Preferably, the programs are main broadcast programs that include information data, such as data 18, associated with such programs. For example, information data associated with such main broadcast programs is a subset of information that includes but is not limited to movie/show titles, names of persons involved with a particular program, a song title, musical artist, record or film company and other short or medium sized data associated with a main broadcast program. It will be appreciated that data other than data associated from a broadcast program also may be transferred, such as stored data on a compact disc, digital video disc, or other stored data not associated with a broadcast program. A display unit 3 displays information data received from the broadcast station stored in a main memory 13 (shown in FIG. 4). The display unit 3 may display information data of a main broadcast program, such as on a television screen of a television receiver, or it may be an additional display unit, such as another liquid crystal display (LCD).

An input/output (I/O) unit 4 is operatively connected to a control unit 16 (shown in FIG. 4), and sends commands to the control unit 16. The control unit 16 controls the transceiving unit 2 in handling and transferring information data 18. Preferably, the input/output unit is a binary input/output unit capable of being activated and deactivated by a user to send commands from the I/O unit 4 to the control unit 16. Preferably, a command sent from an I/O unit 4 is a pulse sequence that is unique with respect to any other commands in a command set. As shown in the Figures, preferably, the input/output unit is a one button manual control which is used as an interface for a user to send commands. It will be appreciated that other means may be employed to accomplish the same function, such as a bar, lever, or handle. In addition, a touch sensitive surface or voice activated binary input/output unit may also be employed. Each of the transceiving units 2 in the transfer devices 10 transmit and receive information data between the local devices 1, as shown by arrowed signal lines 17.

Two local devices 1 are illustrated in FIG. 1 incorporating the data transfer devices 10. Local devices 1 include but are not limited to television and radio receivers. It will be appreciated that additional local devices or even hand held devices also may be employed. Such hand held devices include but are not limited to a remote control device, key, PDA, mobile phone, or pager. In addition the data transfer device 10 may be a stand alone device, and may be as small in size and housed in a key chain or button. A transceiving unit, such as wireless transceiving unit 11 may modulate digital data to become a transmit signal by various known methods such as but not limited to phase shifted keying (PSK), frequency shifted keying (FSK), or amplitude modulation (AM) with electromagnetic wave or infrared ray carriers.

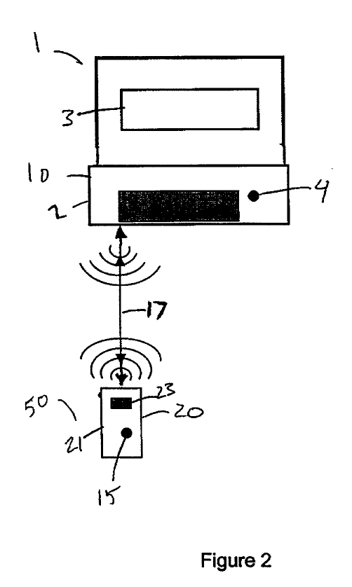

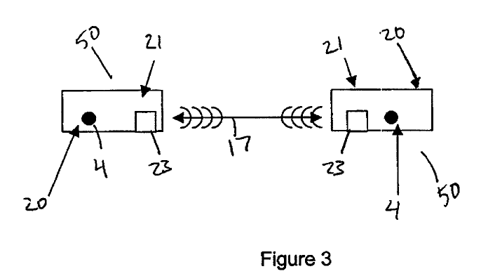

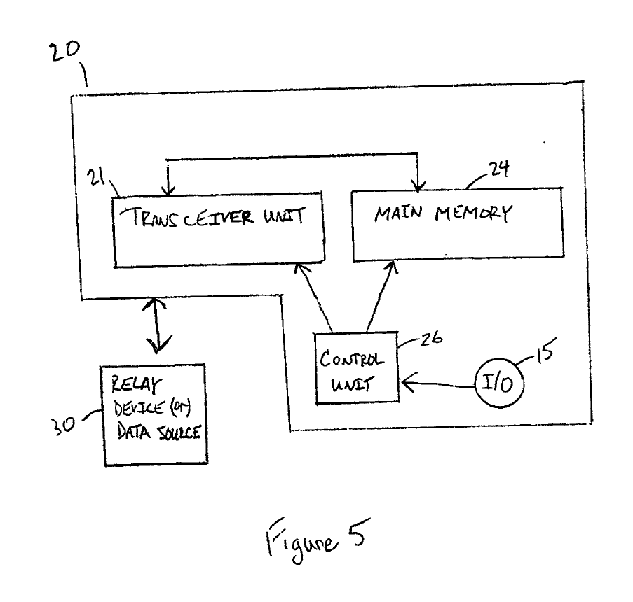

FIG. 2 illustrates information data transfer between a data transfer device 10 of a local device 1 and a personal hand held memory device (PHHM) 50. The PHHM includes data transfer device 20 having a transceiving unit 21 and an I/O unit 15. Preferably, the transceiving unit 21 is a wireless transceiving unit that can modulate digital data to become a transmit signal by various methods as described above. Preferably, the I/O unit 15 operates in the same manner as the I/O unit 4 of a local device as above for sending commands to a control unit 26 (shown in FIG. 5) that controls information data transfer to and from the PHHM 50. FIG. 3 illustrates information data transfer between two personal hand held memory (PHHM) devices 50.

Users can retrieve and transmit data from the data transfer device 10 installed on a local device 1, such as a television set or a radio signal receiver, to a PHHM 50 including the data transfer device 20, as shown in FIG. 2, or between PHHMs as shown in FIG. 3 by a wireless transceiver 11, 21 similar to the data transmission illustrated in FIG. 2. Contents of the information data is displayed on a display unit, such as display units 3, 23 when a user issues a “display command” pressing the corresponding command sequences on the button interface of the I/O units 4, 15. In this way, many commands can be issued, for instance, from a single command button by pressing various pulse sequences, for example Morse code pulse sequences. The details of commands and command sets are further described below.

FIG. 4 illustrates one preferred embodiment of components for the data transfer device 10 for a local device 1. The transfer device 10 receives information data by a transceiving unit 11 that is wireless, or by a transceiving unit 12 that includes a wireline receiver. Information data is received from another relay device or data source 30, such as another local device or a PHHM device or a broadcast station at the wireless transceiving unit 11. The relay device 30 may be a part of a television relay station or radio relay station, or may be a device that is incorporated within or coexistent with a part of broadcast system such as but not limited to a television receiver, pager, satellite television, web radio or web broadcast, and radio receiver. The wireline transceiving unit receives information data from a wireline data source 30a, such as a cable television control unit. Received data from a broadcast station, such as data 18 and broadcast station 5, may be temporarily stored in a buffer memory 13 and replaced by new data when the new data is received. The buffer memory 13 allows for saving space when using a transfer device with limited resources, and may include further buffer space. Such devices may not need to replace temporarily stored data as long as more buffer space(s) are available. Using the I/O unit 4 and its button interface, the data in the buffer memory 13 can be transferred or captured to, and stored in a main memory 14 for further use and handling before being replaced by new data received. The main memory 14 may be a hard disk or random access memory (RAM).

Through the control unit 16, the I/O unit 4 may be operatively connected with a display unit 3, such as but not limited to a liquid crystal display (LCD), plasma, and/or light emitting diode (LED) for displaying the contents of the data information. The control unit 16 is a central processing unit (CPU) that controls reception, transmission, editing, deleting, or adding of data stored in the main memory 14 from commands received by a user operating the I/O unit 4.

FIG. 5 illustrates one preferred embodiment of components for a data transfer device where the device is a PHHM 50. The PHHM 50 is capable of downloading or uploading data in a main memory 24 between another PHHM devices (FIG. 3) or another local device 1 incorporating its own data transfer device (FIG. 2). As shown in FIG. 4, information data is transmitted by wireless transceiver unit 21. It will be appreciated that wireline applications also may be employed. A control unit 26 receives commands from an I/O unit 15 for controlling the main memory 24 and transceiver unit 21 in the same manner as described above in FIG. 4.

One preferred embodiment for a method of handling and transferring data is detailed below for one example of a capture command for capturing data from a main broadcast program. A data transfer device 10, 20, as detailed above, is provided where a user operates the I/O unit to issue a capture command by entering a predetermined pulse sequence. Preferably, this predetermined pulse sequence is defined by activating and deactivating the I/O unit, such as by pressing a one button user interface once, for a predetermined time period. Preferably, the button is pressed at a period of less than 1.0 seconds to send the command to the control unit. More preferably, the button is pressed at a period of less than 0.5 second. The control unit of the device interprets the capture command to control a transceiver unit to capture the data broadcast from the main broadcast program to store the data in a main memory.

The captured data can be used by the user at a later time. For example, the user may purchase a particular product if the captured data is advertisement information such as a product name, price, and location for purchasing the product(s). In addition, the user may set a video recorder to record a particular program if the captured data video program information is a program name, date, channel and time of next broadcast. Further, the user may purchase a music tape or CD of a song or songs if the captured data is the song that was broadcast including other information like the song title, artist name, and location for purchasing the tape or CD.

The captured data can be displayed by a command sent from the user operating the I/O unit issuing a command sequence, where the device includes a display unit, such as LCD, plasma, or LED.

Transferring or relaying the captured data to other devices for use in the same manner as mentioned above can be accomplished by the user issuing a command or plurality of commands by pressing the button interface at a particular pulse sequence.

Preferably, a plurality of commands issued from the button interface of the I/O unit include but are not limited to sending, receiving, displaying, editing, and deleting commands. Particularly, commands may have a nomenclature, for instance, beginning with capture-1 to capture the current data in the buffer. Furthermore, other commands in the nomenclature may be send-i for sending data to another device, delete-1 for deleting data from the device, captured-category for receiving multiple data, send-category for sending multiple data, delete-category for deleting multiple data, sort for sorting data in the main memory, and flush for clearing all data stored in the main memory of the device.

Preferably, the commands are issued by pulse sequences, such as but not limited to Morse code. For instance, capture-1 is issued by a user pressing the button interface once for less than 1.0 seconds when operating the I/O unit. A send-1 command can be issued, for instance, by pressing the user interface button twice. The other commands described above may employ any other pulse sequences. The commands available for an I/O unit to issue in a data transfer device reside in a command set where each command may be any pulse sequence as long as each pulse sequence for each command is unique within the command set.

As above, the I/O units 4, 15 of the data transfer devices 10, 20 may contain at least one button for issuing a command to the control units 16, 26. Preferably, the I/O unit incorporates a single button user interface for issuing commands. The single button may be a designated button on a data transfer device being the PHHM device, or may reside on an existing hand held device such as a television remote control, key, personal digital assistant PDA, mobile phone or pager. Further, the device may be incorporated with other local devices such as but not limited to television and radio receivers. A light emitting diode (LED) or a tone generator (not shown) also may be incorporated with the button user interface in an I/O unit for convenient recognition and confirmation of issued commands by the I/O unit of the device.

In another embodiment, digital data must be modulated from a data source to become a transmit signal by the transceiving unit, as discussed above. For instance, the method may include a radio broadcast data system (RBDS or RDS) in which digital data programs, such as music is transmitted to a consumer and the consumer can use the data transfer device, as above, for capturing the type of music such as pop, rock, country, or classic, etc.

A preferred protocol for issuing pulse sequence commands by a user operating the I/O unit of a data transfer device is described below for the PHHM protocol. Preferably, commands are issued by a user operating the data transfer device following the known seven layers of the Open Systems Interconnect (OSI). The seven OSI layers are the Physical Layer (OSI Layer 1); Data Link Layer (OSI Layer 2); Network Layer (OSI Layer 3); Transport Layer (OSI Layer 4); Session Layer (OSI Layer 5); Presentation Layer (OSI Layer 6); and Application Layer (OSI Layer 7). Preferably, in the PHHM protocol, the OSI standard is applied and is applicable, for instance in examples for the capture-1 and send-1 commands shown in Table 1 below:

TABLE 1

| Command: | capture-1 | send-1 |
|---|---|---|
| Button User | Pressing Once | Pressing Twice |
| Interface: | | |
| Application | 81H | 42H |
| (OSI Layer 7) | | |
| (hexadecimal | | |
| code): | | |
| Presentation | N/A | N/A |
| (OSI Layer 6): | | |
| Session (OSI | Source Device ID | Source Device ID |
| Layer 5) | + Destination Device ID | + Destination Device ID |
| | + Source Running Number | + Source Running Number |
| Transport | Transport Protocol | Transport Protocol |
| (OSI Layer 4) | | |
| Network | N/A | N/A |
| (OSI Layer 3) | | |
| Data Link | Serial Link Protocol or | Serial Link Protocol or |
| (OSI Layer 2) | IrDA Link Access Protocol | IrDA Link Access Protocol |
| | (IrLAP) under Infrared | (IrLAP) under Infrared |
| | Data Association (IrDA) | Data Association (IrDA) |
| Physical | Infrared | Infrared |
| (OSI Layer 1) | | |

In the capture-1 protocol example, pressing the button user interface once, for instance at a period of less than 0.5 seconds, results in a look up command table to recognize that this is the capture command (capture-1). The table reveals a hexadecimal code of 81 (81H or 1000,0001 binary) and sends this code through a transceiving unit of the transfer device to a targeted relay device or another transfer device or data source. Preferably, this code may be modulated in the form of pulses, for instance, when the transmission carrier is IrDA. It will be appreciated that other forms of frequency, such as any available OSI Layer 1 and its corresponding Layer 2, modulation may be employed, such as described above.

The present invention provides a device that can conveniently capture and handle information data associated with a main broadcast program. For example, a user can easily capture, send, edit, data associated with a main broadcast program (i.e. music titles, artists' names, location for purchasing products) by sending a command from the I/O unit of a PHHM by pressing at least one control button at various pulse code sequences to issue particular commands in a manner similar to Morse code.

The above specification, examples and data provide a complete description of the manufacture and use of the invention. Since many embodiments of the invention can be made without departing from the spirit and scope of the invention, the invention resides in the claims hereinafter appended.

We claim:

1. A device for handling and transferring information data, comprising:
a transceiving unit, said transceiving unit transmitting and receiving data;
a control unit operatively connected with said transceiving unit, said control unit controlling data transmission;
a main memory operatively connected to said control unit and controlled by said control unit; said main memory storing said data; and
an input/output unit operatively connected with said control unit; said input/output unit being a binary input/output unit capable of being activated and deactivated for sending at least one command to said control unit; said at least one command being a pulse sequence.

2. A device according to claim 1, wherein said transceiving unit is a wireless transceiving unit.

3. A device according to claim 1, wherein said transceiving unit is wireline transceiving unit including wireline receiver.

4. A device according to claim 1, wherein said device being incorporated with a hand held device.

5. A device according to claim 4, wherein said hand held device selected from the group of a remote control device, key, personal digital assistant (PDA), mobile phone, and a pager.

6. A device according to claim 1, wherein said device residing in a relay device; said relay device is a part of any broadcast system selected from the group of a television receiver, a pager, a satellite television, a web radio, a web broadcast, and a radio receiver.

7. A device according to claim 1, wherein said device residing within a data source; said data source including satellite equipment in a broadcasting station.

8. A device according to claim 1, wherein said device is a stand alone module.

9. A device according to claim 1, wherein said input/output unit defining a one button user interface for sending said at least one command.

10. A device according to claim 1, wherein said pulse sequence defining a capture command, said capture command is defined when said input/output unit is pressed once for a period of less than 1.0 seconds.

11. A device according to claim 1, wherein a buffer memory being operatively connected with said transceiving unit for temporary storing of information data; said buffer memory being operatively connected with said main memory for transferring said information data to said main memory; said buffer memory operatively connected and controlled by said control unit.

12. A device according to claim 1, wherein the information data defining a subset data associated with a main broadcast program.

13. A device according to claim 1, wherein said input/output unit being operatively connected to a display unit through said control unit, said display unit being capable of displaying said information data.

14. A personal hand held memory (PHHM) device for handling and transferring information data, comprising:
a transceiving unit, said transceiving unit transmitting and receiving data;
a control unit operatively connected with said transceiving unit, said control unit controlling data transmission;
a main memory operatively connected to said control unit and controlled by said control unit; said main memory storing said data; and
an input/output unit operatively connected with said control unit; said input/output unit being a binary input/output unit capable of being activated and deactivated for sending at least one command to said control unit for controlling said device; said at least one command being a pulse sequence.

15. A PHHM device according to claim 14, wherein said transceiving unit is a wireless transceiving unit.

16. A PHHM device according to claim 14, wherein said binary input/output unit being a single button user interface for sending at least one command to said control unit for controlling said PHHM device.

17. A PHHM device according to claim 14, wherein said at least one command being a plurality of commands in a command set; said commands each defining its own pulse sequence with respect to other commands in said command set.

18. A PHHM device according to claim 14, wherein said pulse sequence defining a capture command, said capture command is defined when said input/output unit is pressed once for a period of less than 1.0 seconds.

19. A device according to claim 14, wherein the information data defining a subset data associated with a main broadcast program.

20. A device according to claim 14, wherein said input/output unit being operatively connected to a display unit through said control unit, said display unit being capable of displaying said information data.

21. A method for handling and transferring information data, comprising:
providing a data transfer device including a transceiving unit, a control unit operatively connected with said transceiver; a main memory operatively connected with said control unit; and an input/output unit operatively connected with said control unit, said input/output unit being a binary input/output unit;
entering a predetermined pulse sequence defining a command by activating/deactivating said binary input/output unit;
sending said command from said input/output unit to said control unit;
interpreting said command using said control unit;
controlling said transceiving unit and said main memory to receive, handle, and transfer said information data.

22. A method according to claim 21, wherein entering a predetermined pulse sequence includes pressing said input/output unit once for a period of less than 1.0 seconds in a capture command.

23. A method according to claim 21, wherein controlling said main memory including displaying said information data on a display unit operatively connected to said input/output unit through said control unit.

24. A method according to claim 21, wherein controlling said transceiving unit including transferring said information data to another data transfer device.

25. A method according to claim 24, wherein said transferring step including modulating said data to a transmit signal.

26. A method according to claim 21, wherein the information data defining a subset data associated with a main broadcast program.
